(19) United States
(12) Patent Application Publication
(10) Pub. No.: US 2001/0055000 A1
(43) Pub. Date: Dec. 27, 2001

(54) Electrophoretic display device

(76) Inventors: Norihiko Kanae, Fujisawa-shi (JP); Hideyuki Kawai, Fujimi-machi (JP)

Correspondence Address: OLIFF & BERRIDGE, PLC, P.O. BOX 19928, ALEXANDRIA, VA, 22320, US

(21) Appl. No.: 09/828,390

(22) Filed: Apr. 2, 2001

Related U.S. Application Data
(63) Continuation of application No. PCT/JP00/05159, filed on Aug. 2, 2000.

(30) Foreign Application Priority Data
Aug. 6, 1999 (JP) 11-224203

(51) Int. Cl. G09G 3/34

(52) U.S. Cl. 345/107

(57) ABSTRACT

An electrophoretic display device comprised of a microcapsule layer formed on a transparent electrode and coated on its surface with a transparent resin layer effectively preventing a reduction in the display quality, which electrophoretic display device is provided with a substrate layer 11, a conductive film formed on the substrate layer 12, a microcapsule layer 17 having a plurality of microcapsules 16 containing a liquid dispersion medium and electrophoretic particles, and a urethane resin layer 18 formed on the microcapsule layer.

### TECHNICAL FIELD

The present invention relates to an electrophoretic display device which uses movement of electrophoretic particles in a medium due to application of voltage.

### BACKGROUND ART

Japanese Unexamined Patent Publication (Kokai) No. 64-86116 and Japanese Unexamined Patent Publication (Kokai) No. 10-149118 disclose inventions of electrophoretic display devices using microcapsules containing a liquid dispersion medium and electrophoretic particles.

FIG. 3 is a principal sectional view for explaining an example of a conventional electrophoretic display device using microcapsules.

This electrophoretic display device 4 is comprised of a transparent substrate 41a having a transparent electrode 42a and a transparent back substrate 42b having a transparent electrode 42b arranged at a predetermined interval so that the transparent electrode 42a and transparent electrode 42b face each other (this type of electrophoretic display device is called a “counter electrode type electrophoretic display device”).

The transparent substrate 41a and the back substrate 41b are formed from an insulating synthetic resin, for example, PET (polyethylene terephthalate) and the like.

The transparent electrode 42a and the transparent electrode 41b are respectively formed with, for example, a transparent conductive film such as an ITO (indium tin oxide) film.

Between the transparent substrate 41a and the back substrate 42b is provided a microcapsule layer 47 comprised of a large number of microcapsules 46 affixed by a binder material 45.

The microcapsules 46 contain a liquid dispersion of electrophoretic particles 44 dispersed in a dispersion medium 43 individually sealed inside in advance by the microcapsulation method and have natural spherical shapes.

The electrophoretic particles 44 are for example composed of electrophoretic particles such as a white pigment. The dispersion medium 43 is comprised of a colored dispersion medium colored by for example a black coloring agent. The binder material 45 affixing the microcapsules 46 is transparent and has good bondability with the transparent electrodes 42a and 42b.

This electrophoretic device 4 utilizes the phenomenon called “electrophoresis” where the polymer or colloidal organic pigment or inorganic pigment or other colored particles move in a solution due to a difference in potential. By applying a display control voltage to the transparent electrode 42a or 42b to change the state of distribution of the electrophoretic particles 44 in the dispersion system, the optical reflection characteristics are changed to obtain a required display.

The conventional electrophoretic display device 4 changes the display by application of an electric field to the transparent electrodes 42a and 42b above and below the microcapsule layer 47 and is a comparatively large one used as for example an electro-optic display panel.

When desiring to make the electrophoretic display device sheet like in shape like for example a rewritable sheet, it is considered to use not a counter electrode type like in the prior art, but one comprising a microcapsule layer formed on a transparent electrode formed on a substrate and coated on its surface with a transparent resin layer.

In fact, a prototype of such a sheet-like electrophoretic display device has been made. This type of electrophoretic display device displays an image by the movement of the electrophoretic particles in the microcapsule layer as a result of a charge from the outside from the surface of the transparent resin layer.

This electrophoretic display device, however, suffers from the problem of a susceptibility to charging by static electricity on the surface of the transparent resin layer and disturbance of the display when coated on its surface with a later explained silicone-based resin, acryl-based resin, ester-based resin, etc. (deterioration of display quality) and a remarkable deterioration in the display retention under a high temperature (about 60° C.).

### DISCLOSURE OF THE INVENTION

Therefore, the present invention has as its object to provide the electrophoretic display device comprised of a microcapsule layer formed on a transparent electrode and coated on its surface with a transparent resin layer effectively preventing a reduction in the display quality.

The present inventors discovered that by employing a urethane-based resin as this transparent resin, the display quality, in particular the display retention under a high temperature, is remarkably improved and thereby completed the present invention.

That is, the present invention is an electrophoretic display device provided with a substrate layer, a conductive film formed on the substrate layer, a microcapsule layer having a plurality of microcapsules containing a liquid dispersion medium and electrophoretic particles, and a urethane resin layer formed on the microcapsule layer.

In the electrophoretic display device of the present invention, the urethane resin layer is preferably formed from a water-soluble urethane resin composition (urethane resin composition comprised of water as a dispersion medium in which a urethane resin is dispersed) and is preferably formed to a thickness of 20 to 200 μm, more preferably 30 to 100 μm.

Further, the conductive film is preferably a transparent electrode formed on a substrate.

The electrophoretic display device of the present invention is provided with a urethane resin layer on its surface, so is not affected much by static electricity or another outside electric field etc. in room temperature and has a superior display stability.

The electrophoretic display device of the present invention has a superior display stability even under a high temperature.

### BRIEF DESCRIPTION OF THE DRAWINGS

FIG. 1 is a sectional view of the structure of an electrophoretic display device of the present invention.

FIG. 2 gives sectional views of the structures of electrophoretic rewritable sheets obtained in the example and comparative examples. FIG. 2A is a sectional view of the structure of an electrophoretic rewritable sheet of Example 1, while FIG. 2B is one for Comparative Example 1.

FIG. 3 is a sectional view of the structure of a conventional electrophoretic display device.

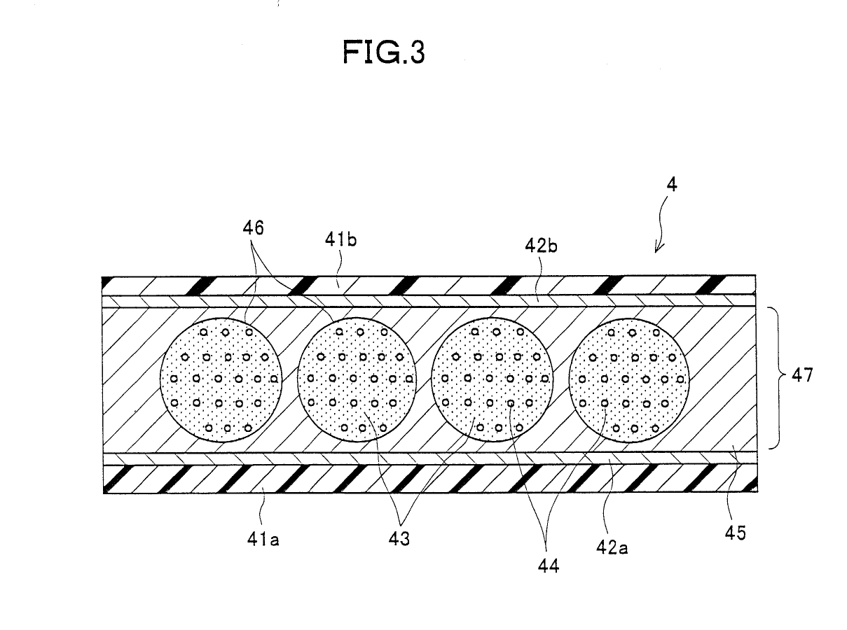

### BEST MODE FOR CARRYING OUT THE INVENTION

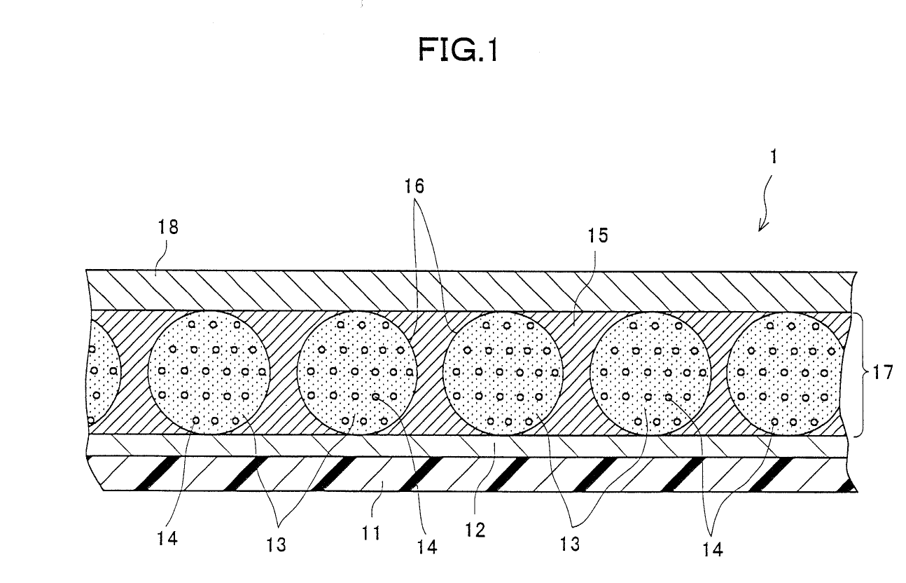

Below, an electrophoretic display device of the present invention will be explained in further detail. FIG. 1 is a principal sectional view for explaining an embodiment according to the present invention.

The electrophoretic device 1 is comprised of a substrate layer 11, a conductive film 12 formed on the substrate layer 11, a microcapsule layer 17 containing a plurality of microcapsules sealing inside a dispersion system including a liquid dispersion medium 13 and electrophoretic particles 14, and a urethane resin layer 18 formed on the microcapsule layer 17.

In the electrophoretic device 1, by grounding the conductive film 12, spraying for example ions from the surface of the urethane resin layer 18 to make the electrophoretic particles 14 move due to the charge, and thereby changing the state of distribution of the electrophoretic particles 14 in the dispersion system, the optical reflection characteristics are changed and the required image is displayed.

In the electrophoretic display device 1 of the present invention, the substrate layer 11 is not particularly limited so long as it is comprised of a material having an insulating ability and able to carry (or able to support or able to hold) the conductive film 12. It is possible to use various substrates. As the substrate, a glass substrate, ceramic substrate, paper substrate, insulating synthetic resin substrate, flexible circuit board, glass epoxy resin, or other substrate etc. may be used.

As the glass substrate, for example, silicate glass (quartz glass), alkali silicate glass, soda-lime glass, potassium-lime glass, lead glass, barium glass, borosilicate glass, etc. may be used. As the ceramic substrate, for example, a porcelain sheet etc. may be used. As the paper, fine paper, Japanese paper, high filler-content paper, nonwoven fabric, etc. may be used.

Further, as the insulating synthetic resin substrate, the ones illustrated below may be used.

(a) Polyethylene, chlorinated polyethylene, ethylene-vinyl acetate copolymer, ethylene-ethyl acrylate copolymer, polypropylene, ABS resin, methyl methacrylate resin, vinyl chloride resin, vinyl chloride-vinyl acetate copolymer, vinyl chloride-vinylidene chloride copolymer, vinyl chloride-acrylic acid ester copolymer, vinyl chloride-methacrylic acid copolymer, vinyl chloride-acrylonitrile copolymer, ethylene-vinyl alcohol-vinyl chloride copolymer, propylene-vinyl chloride copolymer, vinylidene chloride resin, vinyl acetate resin, polyvinyl alcohol, polyvinyl formal, cellulose-based resin, or other thermoplastic resin,

(b) polyamide-based resin, polyacetal, polycarbonate, polyethylene terephthalate, polybutylene terephthalate, polyphenylene oxide, polysulfone, polyamide imide, polyamino bismaleimide, polyether sulfone, polyphenylene sulfone, polyarylate, graft polyphenylene ether, polyether ether ketone, polyether imide, and other heat resistant, mechanically strong polymers,

(c) polyethylene tetrafluoride, polyethylene propylene fluoride, ethylene tetrafluoride-perfluoroalkoxyethylene copolymer, ethylene-ethylene tetrafluoride copolymer, polyvinylidene fluoride, polyethylene trifluorochloride, fluororubber, or other fluororesins, and

(d) silicone resins, silicone rubber, and other silicone resins

As other insulating synthetic resin substrates, a methacrylic acid-styrene copolymer, polybutylene, methyl methacrylate-butadiene-styrene copolymer, etc. may be used.

In the electrophoretic display device 1 of the present invention, a conductive film 12 is formed on the substrate layer 11. As the conductive film 12, for example, an indium tin oxide film (ITO film), fluorine tin oxide film (FTO film), antimony zinc oxide film, indium zinc oxide film, aluminum zinc oxide film, etc. may be preferably illustrated.

The method of forming the conductive film 12 is not particularly limited, but for example the film may be formed by the sputtering method, electron beam method, ion plating method, vacuum deposition method, chemical vapor deposition (CVD) method, etc. Further, the conductive film 12 may be formed on the entire surface of the substrate 11.

In the electrophoretic display device 1 of the present invention, a microcapsule layer 17 comprised of a plurality of microcapsules 16 is formed on the conductive film 12. The microcapsules 16 contain sealed in them a dispersion system comprised of electrophoretic particles 14 dispersed in a liquid dispersion medium 13.

As the liquid dispersion medium 13 used in the dispersion system, water, methanol, ethanol, isopropanol, butanol, octanol, methyl cellosolve, and other alcohol-based solvents, ethyl acetate, butyl acetate, and other various esters, acetone, methylethylketone, methylisobutylketone, and other ketones, pentane, hexane, octane, and other aliphatic hydrocarbons, cyclohexane, methylcyclohexane, and other alicyclic hydrocarbons, benzene, toluene, xylene, hexylbenzene, and other aromatic hydrocarbons, methylene chloride, chloroform, carbon tetrachloride, 1,2-cycloethane, and other halogenated hydrocarbons, carboxylates, and other various oils and the like alone or in mixtures plus a surfactant etc. may be used.

Further, the electrophoretic particles 14 mean particles (polymers or colloids) having the nature of moving to the transparent electrode side by electrophoresis due to the potential difference in the dispersion medium 13. For example, Aniline Black, carbon black, or other black pigments, titanium dioxide, zinc oxide, antimony trioxide, and other white pigments, monoazo, dis-azo, polyazo, and other azo-based pigments, isoindolenone, yellow lead oxide, yellow iron oxide, cadmium yellow, titanium yellow, antimony, and other yellow pigments, monoazo, dis-azo, polyazo, and other azo-based pigments, quinacrilidone red, chrome vermillion, and other red pigments, phthalocyanine blue, indanthrene blue, anthraquinone-based dyes, prussian blue, ultramarine blue, cobalt blue, and other blue pigments, phthalocyanine green and other green pigments alone or in combinations of two or more types may be used.

Further, these pigments may have added to them, in accordance with need, an electrolyte, surfactant, metal soap, resin, rubber, oil, varnish, a charge controlling agent comprised of particles of a compound etc., a titanium coupling agent or other dispersant, lubricant, stabilizer, etc.

The dispersion system comprised in this way is sufficiently intimately mixed by a ball mill, sandmill, paint shaker, or other suitable means, then made into microcapsules by the surface polymerization method, insoluble reaction method, phase separation method, surface precipitation method, or other known microcapsulation method.

As the material for making the microcapsules 16, a gum arabi- and gelatin-based compound or urethane-based compound or other material having flexibility is preferably used. Further, the microcapsules are preferably substantially uniform in size in order to obtain a superior display performance. Microcapsules of substantially uniform size may be obtained by using for example filtration,_separation by difference of specific gravity, etc. The size of the microcapsules is normally about 30 to 60 μm.

The microcapsule layer 17 may be formed by mixing the above microcapsules 16 in a binder resin 15 together with a dielectric rate adjuster if desired and coating the obtained resin composition (emulsion or organic solvent solution) on a substrate by the method of using a roll coater, the method of using a roll laminator, the method of screen printing, the spray method, or other known coating method.

The binder resin 15 able to be used is not particularly limited so long as it has a good affinity with the microcapsules 16, is superior in bondability with the substrate 11, and has an insulating ability.

As the binder resin 15, it is possible to use the following in the same way as the above insulating synthetic resin substrate: polyethylene, chlorinated polyethylene, ethylene-vinyl acetate copolymer, ethylene-ethyl acrylate copolymer, polypropylene, ABS resin, methyl methacrylate resin, vinyl chloride resin, vinyl chloride-vinyl acetate copolymer, vinyl chloride-vinylidene chloride copolymer, vinyl chloride-acrylic acid ester copolymer, vinyl chloride-methacrylic acid copolymer, vinyl chloride-acrylonitrile copolymer, ethylene-vinyl alcohol-vinyl chloride copolymer, propylene-vinyl chloride copolymer, vinylidene chloride resin, vinyl acetate resin, polyvinyl alcohol, polyvinyl formal, cellulose-based resin, or other thermoplastic resin,.

Polyamide-based resin, polyacetal, polycarbonate, polyethylene terephthalate, polybutylene terephthalate, polyphenylene oxide, polysulfone, polyamide imide, polyamino bismaleimide, polyether sulfone, polyphenylene sulfone, polyarylate, grafted polyphenylene ether, polyether ether ketone, polyether imide, and other heat resistant, mechanically strong polymers.

Polyethylene tetrafluoride, polyethylene propylene fluoride, ethylene tetrafluoride-perfluoroalkoxyethylene copolymer, ethylene-ethylene tetrafluoride copolymer, polyvinylidene fluoride, polyethylene trifluorochloride, fluororubber, or other fluororesins.

Silicone resins, silicone rubber, and other silicone resins.

As the other binder material 15, a methacrylic acid-styrene copolymer, polybutylene, methyl methacrylate-butadiene-styrene copolymer, etc. may be used.

Further, the binder material 15 preferably makes the dielectric rate of the electrophoretic display solution and the dielectric rate of the dispersion material substantially the same as described in Japanese Unexamined Patent Publication (Kokai) No. 10-149118. Therefore, the binder resin composition for example has an alcohol, ketone, carboxylate, etc. added to it. As the alcohol, 1,2-butanediol, 1,4-butanediol, etc. may be used.

In the electrophoretic display device 1 of the present invention, a urethane resin layer 18 is formed on the microcapsule layer 17. The urethane resin layer 18 performs the function of protecting the microcapsule layer 17 and enhancing the display stability, in particular the display retention under a high temperature.

The urethane resin layer 18 is comprised of a urethane resin. The urethane resin basically means a urethane resin having a polyol as a main ingredient and an isocyanate as a cross-linking agent (curing agent).

As the isocyanate, a polyhydric isocyanate having at least two isocyanate groups in a molecule is preferably used. For example, 2,4-tolylene diisocyanate, xylene diisocyanate, 4,4′-diphenylmethane diisocyanate, or another aromatic isocyanate, hexamethylene diisocyanate, isohoron diisocyanate, hydrogenated tolylene diisocyanate, or other aliphatic isocyanate etc. may be used.

As the polyol, one illustrated below may be used.

One having at least two hydroxyl groups in a molecule, for example, ethyleneglycol, propyleneglycol, neopentylglycol, 1,2-butanediol, 1,4-butanediol, 3-methyl-1,5-pentanediol, or other diol.

Diethyleneglycol, trimethyleneglycol, or other polyol.

Acryl polyol, polyether polyol, polycarbonate polyol, hydrogenated bisphenol A, trimethylol propane, etc.

Further, as the resin comprising the urethane resin layer 18, a water-soluble urethane resin is particularly preferably used. As the water-soluble urethane resin, for example, the urethane resin described in Japanese Unexamined Patent Publication (Kokai) No. 7-133442 may be used. As the urethane resin, it is possible to use one having a carboxyl group and stably dispersed or dissolved in water by neutralization by a neutralizing agent.

The urethane resin may be obtained from a urethane resin solution produced by reacting a polyhydric alcohol not having a carboxyl group, a polyhydric alcohol having a carboxyl group, a polyhydric isocyanate compound, and chain extender in accordance with need in the presence or absence of an organic solvent by a one-shot method by an ordinary method or multistage method, mixing this with water after neutralization or during neutralization, and removing the organic solvent in accordance with need.

Further, as the polyhydric alcohol not having the carboxyl group, the above various polyols may be preferably used.

Further, as the polyhydric alcohol having the carboxyl group, for example, dimethylol propionic acid, dimethylol acetic acid, dimethylol butyric acid, dimethylol valeric acid, dihydroxysuccinic acid, dihydroxy adipic acid, lactic acid, tartaric acid, gluconic acid, citric acid, malic acid, etc. may be mentioned.

Further, it is also possible to use an ester of trimethylol ethane or glyceryl or other polyhydric alcohol and phthalic acid, malonic acid, adipic acid, succinic acid, and other polybasic acids (half esters) etc.

As the chain extender, for example, ethylene diamine, propylene diamine, tolylene diamine, xylene diamine, isohoron diamine, and other diamines may be given as typical examples.

These water-soluble urethane resin compositions may be neutralized using a base such as trimethylamine, triethylamine, triethanolamine, ammonia, etc., preferably neutralized to pH7 to 11, and made a water solution or water dispersion by the addition of water.

The water-soluble urethane resin has a molecular weight of 5000 to 2,000,000 or so, preferably 10,000 to 1,000,000 or so. If the molecular weight is smaller than this range, the water resistance etc. falls, while conversely if larger, the pliability etc. tends to fall. Further, the acid value is suitably 10 to 50. If the acid value is smaller than this range, the stability of the paint falls, while conversely if large, the water resistance tends to fall.

As commercially available products of this water-soluble urethane resin, for example, Sancure 825, 822A (made by Gunze Sangyo), 9D232, 9D302 (made by Kanebo NSC), U-coat UX-2505, UX-4300 (made by Sanyo Chemical Industries), Bondex (made by Dainippon Ink & Chemicals), Neoretz (made by ICI Resins), Olester (made by Mitsui Chemical), SuperRex (made by Daiichi Kogyo Seiyaku), Water-Soluble View Urethane (made by Dainippon Paint), etc. may be mentioned.

Further, in addition, it is possible to use the water-soluble urethane resins described in Japanese Unexamined Patent Publication (Kokai) No. 58-7422, Japanese Unexamined Patent Publication (Kokai) No. 59-71324, Japanese Unexamined Patent Publication (Kokai) No. 59-170112, Japanese Unexamined Patent Publication (Kokai) No. 62-246972, Japanese Unexamined Patent Publication (Kokai) No. 63-66266, Japanese Unexamined Patent Publication (Kokai) No. 3-195786, Japanese Unexamined Patent Publication (Kokai) No. 4-214784, and other publications.

Note that as the organic solvent used when obtaining the water-based dispersion solution of the water-soluble urethane resin, for example, methanol, ethanol, isopropanol, butanol, octanol, ethylene glycol, and other alcohol-based solvents, ethyl acetate, butyl acetate, and other various esters, acetone, methyl ethyl ketone, methyl isobutylketone, and other ketones, pentane, hexane, octane, and other aliphatic hydrocarbons, cyclohexane, methylcyclohexane, and other alicyclic hydrocarbons, benzene, toluene, xylene, hexylbenzene, and other aromatic hydrocarbons, methylene chloride, chloroform, carbon tetrachloride, 1,2-dicycloethane, and other halogenated hydrocarbons, carboxylates, N-methylpyrrolidone, N, N-dimethylformamide, and other amides, tetrahydrofuran, dioxane, methyl cellosolve, and other ether-based solvents, dimethylsulfoxide, acetonitrile, or other various oils alone or in mixtures plus a surfactant may be used.

Further, in the present invention, it is possible to use an acryl-based resin, olefin-based resin, etc. mixed into the urethane resin.

As the acryl-based resin, for example, methyl polyacrylate, ethyl polyacrylate, butyl polyacrylate, ethyl acrylate-butyl acrylate copolymer, ethyl acrylate-styrene copolymer, polymethyl methacrylate, polymethyl methacrylate, polybutyl methacrylate, ethyl methacrylate-butyl methacrylate copolymer, ethyl methacrylate-styrene copolymer, etc. may be used.

As the olefin-based resin, for example, polyethylene, polypropylene, polymethylpentene, ethylene-propylene copolymer, ethylene-propylene-butene copolymer, ethylene-vinyl acetate copolymer, ethylene-polyvinyl alcohol copolymer, etc. may be used.

Further, it is possible to further add to these resins various optical stabilizers, antioxidants, etc. to impart light resistance or heat stability.

For example, a benzotriazole-based, benzophenone-based, or salicylate-based UV absorbent, a phenol-based, hindered amine-based, phosphorus-based, or sulfur-based antioxidant, phosphite, epoxy compound, β-diketone compound, polyol, or other heat stabilizer etc. may be used.

Further, in addition, it is possible to add various additives such as 2,2,4-trimethylpentanediol-1,3-butylate, benzotriazole, and methylester pyromellitate.

The urethane resin layer is preferably formed to a thickness of 20 to 200 μm, more preferably 30 to 100 μm. If the thickness of the urethane resin layer is less than 20 μm, the effect of protection of the surface and the effect of enhancing the display stability are poor. If over 200 μm, the effect of enhancing the display stability becomes saturated and the transparency falls.

The write operation of display data to the electrophoretic display device 1 may be performed by grounding the conductive layer 12, charging the surface of the urethane resin layer 18 by applying an electric field from the outside, for example, spraying ions, and making the electrophoretic particles 14 move.

The electrophoretic display device of the present invention may for example be used as a rewritable card, rewritable sheet, rewritable paper, or other display device in the field of public display, digital paper and displays of computers, portable data terminals, and other information devices, and other display devices in the field of data communications.

Next, the present invention will be explained in further detail using examples. Note that the following explanation is only of an embodiment of the present invention. The types etc. of the substrate, conductive film, urethane resin, electrophoretic particles, etc. sealed in the microcapsules etc. may be freely changed within the scope of the gist of the present invention.

### EXAMPLE 1

### Fabrication of Electrophoretic Rewritable Sheet

First, as the substrate having the conductive layer 22, a PET (polyethylene terephthalate) film 21 coated with an ITO film of a thickness of 1 to 2 μm was prepared. Next, as the electrophoretic display solution to be sealed inside, 12 parts of titanium oxide, 1.5 parts by weight of a surfactant, 0.5 part by weight of a titanium-based coupling agent, 1 part by weight of a blue anthraquinone-based dye, and 85 parts by weight of dodecyl benzene as a dispersion medium 25 were mixed by ultrasonic wave dispersion. Microcapsules 26 of an average particle size of 35 microns were prepared by the gum arabi-gelatin based composite core celvation method.

Next, the obtained microcapsules 26 and, as a binder material 23, an emulsion type silicone-based coating agent (made by Shin-Etsu Silicone, product name: POLON-MF-40) were mixed by a weight ratio of 2:1. The resin emulsion was coated on a PET film 31 with the ITO film to form the microcapsule layer 27.

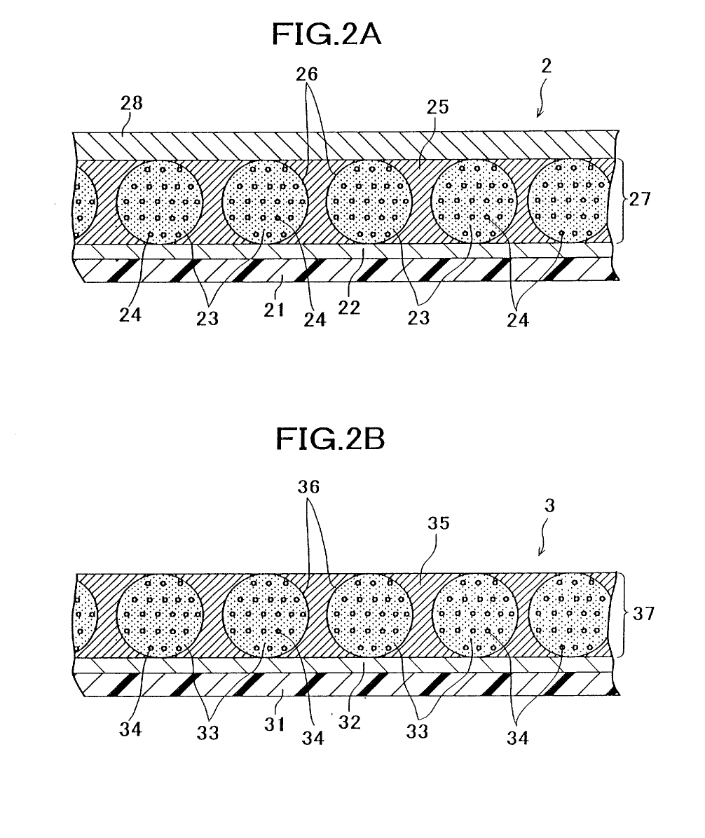

Further, a urethane-based resin (made by Dainippon Paint, product name: Water-Soluble View Urethane) was uniformly coated to a thickness of 30 μm on the microcapsule layer 27 using a roll coater, then a urethane resin layer 28 was formed by the method of drying by hot air (for example, 90° C., 10 minutes) and thereby fabricate an electrophoretic rewritable sheet 2 as shown in FIG. 2A.

### COMPARATIVE EXAMPLE 1

### Fabrication of Electrophoretic Rewritable Sheet

The same procedure was followed as in Example 1 to fabricate an electrophoretic rewritable sheet 3 of the comparative example shown in FIG. 2B except for not forming the urethane resin layer of Example 1.

### COMPARATIVE EXAMPLE 2

### Fabrication of Electrophoretic Rewritable Sheet

The same procedure was followed as in Example 1 to fabricate an electrophoretic rewritable sheet of Comparative Example 2 having a layer configuration similar to the electrophoretic rewritable sheet of Example 1 except for forming a layer (thickness 30 microns) comprised of a silicone-based resin (made by Shin-Etsu Chemical, product name: POLON-MF-40) instead of the urethane resin layer of Example 1.

### COMPARATIVE EXAMPLE 3

### Fabrication of Electrophoretic Rewritable Sheet

The same procedure was followed as in Example 1 to fabricate an electrophoretic rewritable sheet of Comparative Example 3 having a layer configuration similar to the electrophoretic rewritable sheet of Example 1 except for forming a layer (thickness 30 microns) comprised of an acryl-based resin (made by Mitsui Chemical, product name: E272) instead of the urethane resin layer of Example 1.

### COMPARATIVE EXAMPLE 4

### Fabrication of Electrophoretic Rewritable Sheet

The same procedure was followed as in Example 1 to fabricate an electrophoretic rewritable sheet of Comparative Example 4 having a layer configuration similar to the electrophoretic rewritable sheet of Example 1 except for forming a layer (thickness 30 microns) comprised of an ester-based resin (made by Toyo Morton, product name: THW-3257) instead of the urethane resin layer of Example 1.

### Display Stability Test Due to Effect of Outside Electric Field

The display stability due to the effect of the outside electric field was tested as follows using the electrophoretic rewritable sheets prepared in Example 1 and Comparative Examples 1 to 4. That is, the electrophoretic rewritable sheets prepared in Example 1 and Comparative Examples 1 to 4 were set to predetermined display states, the surfaces were charged to 5 kV, and the sheets were allowed to stand at room temperature for 24 hours. As a result, the electrophoretic rewritable sheet of Example 1 did not show any change in the display state, but the displays of the electrophoretic rewritable sheets of Comparative Examples 1 to 4 were lost. From this, it was learned that the electrophoretic rewritable sheet of Example 1 has a superior display stability.

### Display Stability Test Under High Temperature Environment

The display stability was tested under the following high temperature environment using the electrophoretic rewritable sheets prepared in Example 1 and Comparative Examples 1 to 4. That is, the electrophoretic rewritable sheets prepared in Example 1 and Comparative Examples 1 to 4 were set to predetermined display states, placed in a high temperature environment of 60° C., and the display states after the elapse of one hour were investigated by a luminance meter.

As a result, the contrast ratio of the display state of the electrophoretic rewritable sheet of Example 1 fell about 10 percent. On the other hand, the contrast ratio of the display state of the electrophoretic rewritable sheet of Comparative Example 1 fell about 95 percent. Further, the contrast ratios of the display states of the electrophoretic rewritable sheets of Comparative Examples 2 to 4 were about the same as the case of the electrophoretic rewritable sheet of Comparative Example 1. From this, it was learned that the electrophoretic rewritable sheet of Example 1 had a superior display stability even under a high temperature environment.

### INDUSTRIAL APPLICABILITY

As explained above, the electrophoretic display device of the present invention is provided with a urethane resin layer at its surface, so is not influenced much by static electricity or other outside electric field at room temperature and has a superior display stability.

Further, the electrophoretic display device of the present invention has a superior display stability even under a high temperature.

### LIST OF REFERENCES

1 . . . electrophoretic display device of present invention

2 . . . electrophoretic rewritable sheet of Example 1

3 . . . electrophoretic rewritable sheet of Comparative Example 1

4 . . . conventional electrophoretic display device

11 . . . substrate (layer)

12, 22, 32 . . . conductive film

13, 23, 33, 43 . . . dispersion medium

14, 24, 34, 44 . . . electrophoretic particles

15, 25, 35, 45 . . . binder material

16, 26, 36, 46 . . . microcapsules

17, 27, 37, 47 . . . microcapsule layer

18, 28 . . urethane resin layer

21, 31 . . . PET film

41a . . . transparent substrate

41b . . . back substrate

42a, 42b . . . transparent electrode

1. An electrophoretic display device comprising:
a substrate layer;
a conductive film formed on the substrate layer;
a microcapsule layer having a plurality of microcapsules containing a liquid dispersion medium and electrophoretic particles; and
a urethane resin layer formed on the microcapsule layer.

2. An electrophoretic display device as set forth in claim 1, wherein the urethane resin layer is formed from a urethane resin composition.

3. An electrophoretic display device as set forth in claim 1, wherein the urethane resin layer is formed to a thickness of 20 to 200 μm.

4. An electrophoretic display device as set forth in claim 1, wherein the conductive film is a transparent electrode formed on the substrate layer.
